(19) United States
(12) Patent Application Publication
(10) Pub. No.: US 2026/0205462 A1
(43) Pub. Date: Jul. 16, 2026

(54) Group Network Theory Modeling Engine for Influence-Based Group Dynamics

(71) Applicant: George William Bickerstaff, Greenwich, CT (US)

(72) Inventor: George William Bickerstaff, Greenwich, CT (US)

(21) Appl. No.: 19/305,697

(22) Filed: Aug. 20, 2025

(51) Int. Cl. H04L 9/40; G06F 9/451

(52) U.S. Cl. CPC H04L 63/104; G06F 9/451

(57) ABSTRACT

Embodiments disclose a modular, computer-implemented Group Network Theory (GNT) engine for modeling, forecasting, and optimizing group dynamics from validated multi-source data. The engine ingests authenticated membership and relationship records and applies consensus corroboration, anomaly screening, provenance hashing, and privacy safeguards. A group influence mapping model mapping model computes cohesion, centrality, and balance indices and generates trust maps. A trust propagation simulation applies reinforcement and decay, evaluates resilience under perturbations, and tracks feedback loops to produce time-series trajectories. An adaptive configuration panel supports adjustments to membership, weightings, and structural factors with scenario testing and quantified impact views. A forecasting and analytics interface provides composite forecast scores, comparative analytics, trust maps, and exportable reports. In some embodiments, at least a portion of identity resolution and provenance hashing executes within a hardware-backed trusted execution environment (secure enclave), isolating cryptographic material and intermediate artifacts from the host operating system.

### CROSS-REFERENCE TO RELATED APPLICATIONS

This application claims the benefit of U.S. Provisional Patent Application No. 63/847,054, filed on Jul. 19, 2025, the entire contents of which are incorporated herein by reference. Modules disclosed herein correspond to the “Group Influence Data Layer,” “Simulation Engine,” “Group Fit and Forecasting Module,” “Adaptive Design Interface,” and “Dashboard and Export Tools” of the provisional application.

### CPC Classifications:

G06Q 50/01 (organizational management; workflow; social networking)
G06F 16/9535 (decision optimization with structured data; search customization based on user profiles)
G06N 20/00 (machine learning for decision support)

### BACKGROUND OF THE INVENTION

### Technical Field

The subject matter disclosed herein relates to computer-implemented systems and methods for modeling, analyzing, and optimizing influence-based group structures in organizational and governance contexts. In particular, it concerns the application of Group Network Theory to evaluate properties such as collective trust, cohesion, centrality, and mission alignment.

### Background

Conventional approaches for evaluating individuals and groups include surveys and 360-degree feedback tools. These methods often depend on self-report and rater judgment, making results sensitive to bias, sampling effects, and inconsistent administration across teams and time.

Static assessment frameworks measure predefined competencies or role attributes. While useful for snapshots, they generally do not capture temporal dynamics in influence or trust, nor do they reflect how relationships evolve in response to membership changes, incentives, or external shocks.

Social network analysis techniques map connections among participants and yield structural metrics (e.g., degree, betweenness, clustering). Such frameworks typically do not integrate multi-source verification of the underlying influence data, do not model trust propagation with reinforcement and decay, and do not quantify resilience of the group under perturbations or counterfactual scenarios.

Governance and organizational design platforms provide dashboards and descriptive analytics. These systems commonly lack engines for simulating group dynamics, performing scenario testing, or optimizing coalition structure against stated objectives and constraints. They also tend not to produce machine-auditable outputs suitable for compliance processes or external review.

From a data integrity standpoint, influence and credential records may originate from disparate repositories. Conventional systems provide limited cross-corroboration across sources, inconsistent identity resolution, and insufficient provenance tracking. Cryptographically verifiable audit trails are not typically available, which can hinder repeatability, traceability, and third-party validation.

Accordingly, there remains a need for computer-implemented frameworks that: ingest authenticated membership and relationship records from multiple sources; perform consensus corroboration and anomaly screening; apply provenance hashing to support traceable audit trails; compute group-level indices of cohesion, centrality, and balance; simulate trust propagation and resilience over time; and enable adaptive scenario testing and optimization with privacy safeguards. The present disclosure addresses these needs.

### SUMMARY OF THE INVENTION

In one or more embodiments, a modular, computer-implemented framework models, analyzes, and optimizes group dynamics under principles of Group Network Theory. The framework integrates validated multi-source data, dynamic trust simulation, and adaptive group optimization within a single system.

The system ingests authenticated membership and relationship records from independent repositories and validates them via consensus corroboration, anomaly screening, provenance hashing, and privacy safeguards. From the validated corpus, the system constructs group influence models that compute indices including cohesion, centrality, and balance and generates trust maps.

A simulation engine models propagation of influence and trust across relationships under varying conditions by applying reinforcement and decay dynamics, evaluating resilience under perturbations, and assessing mission alignment. This supports predictive analysis of behavior under internal changes and external shocks.

An adaptive design capability permits real-time configuration of membership, weighting, and structural factors subject to user-defined objectives and constraints. Scenario testing and impact analysis quantify the effects of proposed adjustments and support optimization of group composition and governance structures.

Outputs are presented through a forecasting and analytics interface that provides trust maps, composite forecast scores, comparative benchmarks, and exportable, machine-auditable reports suitable for organizational decision-making. In some embodiments, provenance hashes are anchored to a blockchain, and model training and scoring are performed via federated learning across distributed repositories to support auditability, scalability, and privacy.

### BRIEF DESCRIPTION OF THE DRAWINGS

FIG. 1 is a block diagram of a Group Network Theory (GNT) engine (100) showing data ingestion and validation, a group influence mapping model (200), a trust propagation simulation flow (300), an adaptive group design panel (400), and a group performance forecast dashboard (500).

FIG. 2 is a block diagram of the group influence mapping model (200) that computes cohesion, centrality, and balance indices and generates trust maps.

FIG. 3 is a flow diagram of the trust propagation simulation (300) applying reinforcement and decay dynamics, resilience perturbation testing, and feedback handling to produce time-series trajectories.

FIG. 4 is a user-interface schematic of the adaptive group design panel (400) enabling configuration of membership, weightings, constraints, and scenarios with impact visualization.

FIG. 5 is a dashboard schematic of the group performance forecast dashboard (500) providing trust maps, composite forecast scores, comparative analytics, and exportable reports.

### DEFINITIONS FOR CLARITY

Adaptive design panel: A user interface that enables configuration of membership, weighting, constraints, and scenarios, and that invokes system functions to recompute metrics and forecasts based on those configurations.

Anomaly screening: Statistical and rules-based techniques that flag records or features whose values deviate from expected distributions, schemas, or cross-source patterns.

Balance index: A normalized metric quantifying whether relational influence or trust is evenly distributed across members or concentrated in a subset.

Blockchain anchoring: Storing cryptographic commitments (e.g., hashes) of provenance records on a distributed ledger to provide tamper-evident timestamping.

Centrality index: A quantitative measure of a node's positional influence within a network (e.g., degree-like, betweenness-like, or eigenvector-like constructs implemented by the system).

Cohesion index: A computed measure of group connectivity strength based on edge weights, path structure, or community stability.

Comparative benchmark: A reference distribution or score derived from peer groups or historical cohorts used to contextualize a group's metrics or forecasts.

Consensus corroboration: Cross-referencing independent repositories to confirm an attribute, credential, or relationship, using one or more criteria such as majority agreement, quorum thresholds, confidence-weighted voting, or temporal concordance.

Federated learning: Training or scoring performed across multiple data repositories without exchanging raw data, combining model parameters, gradients, or intermediate statistics to produce global updates.

Governance optimization: An optimization procedure that selects or recommends group composition, roles, or weightings subject to stated objectives and constraints.

Identity resolution: Determining that two or more records refer to the same entity using deterministic keys, probabilistic matching, or cryptographic fingerprints.

Influence record: A data structure representing a membership, credential, interaction, endorsement, or other relationship relevant to group influence or trust.

Mission alignment: A measure of consistency between a proposed or observed group configuration and declared objectives, values, or policies.

Perturbation: A modeled change to membership, edges, weights, or exogenous conditions used to evaluate resilience.

Provenance hashing: Cryptographic hashing of normalized records, model configurations, and outputs, optionally including timestamps and source identifiers, to form an auditable chain of custody.

Resilience score: A metric computed from simulation results indicating stability of performance or connectivity under specified perturbations.

Scenario testing: Executing simulations under hypothesized configurations or constraints and recording predicted changes in metrics and outputs.

Trust map: A data representation (and optionally a visualization) of directed and/or undirected relationships with associated trust or influence weights.

Trust propagation simulation: A dynamic update process that applies reinforcement and decay functions, feedback handling, and constraint rules to estimate future trust or influence states.

Validated multi-source data: A dataset produced by ingesting authenticated records from independent repositories and applying consensus corroboration, anomaly screening, provenance hashing, and privacy safeguards.

Weighting: A set of coefficients applied to features, edges, or objectives that influence metric computation or optimization outcomes.

### DETAILED DESCRIPTION OF THE INVENTION

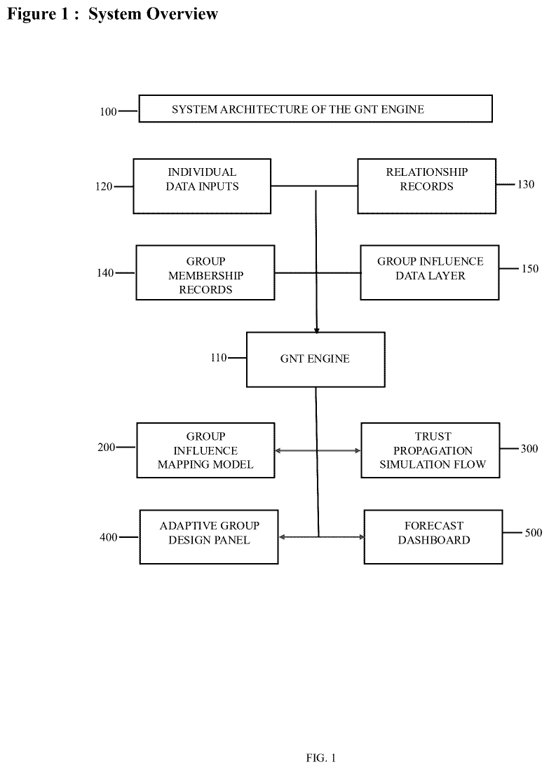

### Detailed Description of FIG. 1—System Architecture of the GNT Engine (100-500)

FIG. 1 illustrates the System Architecture of the Group Network Theory (GNT) Engine (100), which is a modular, computer-implemented framework designed to transform validated multi-source inputs into influence mappings, trust simulations, adaptive configuration models, and actionable performance forecasts. The architecture operates in sequential yet interdependent stages, ensuring integrity, scalability, and reproducibility.

### Individual Data Inputs (110):

The system ingests authenticated and structured records, including user attributes, verified influence indices, relationship histories, and metadata retrieved from independent repositories. These inputs form the foundational dataset upon which group dynamic modeling is performed.

### Validation Module (120):

Incoming records are processed through validation routines, including consensus corroboration across repositories, anomaly screening for statistical outliers, and provenance hashing to preserve cryptographic audit trails. This ensures that only high-integrity data is propagated downstream, thereby supporting audit-ready compliance.

### Relationship Records (130):

Validated inputs are structured into dyadic connection records, capturing authenticated collaborations, co-membership logs, and verified communications between two or more entities.

These records allow mapping of trust pathways within groups.

### Group Membership Records (140):

Complementing relationship records, membership records define group inclusion and affiliation data, capturing roles, rights, hierarchical structures, and participatory metadata.

### Group Influence Data Layer (150):

This transitional layer integrates validated relationship records (130) and membership records (140) into a unified schema. It standardizes data for subsequent modeling while enabling scalability across distributed and cloud environments, ensuring support for high-volume, multi-organizational implementations.

### Group Influence Mapping Model (200):

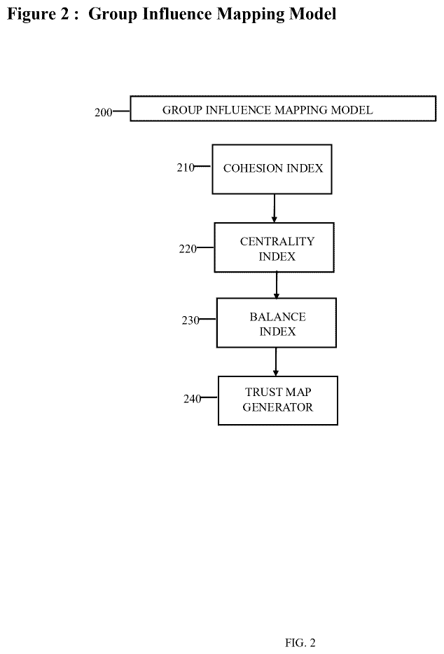

The structured dataset is transformed into quantifiable influence measures, including cohesion, centrality, balance, and trust mapping indices. These indices serve as baseline metrics for evaluating group structure and internal dynamics. (Expanded in FIG. 2).

### Trust Propagation Simulation Flow (300):

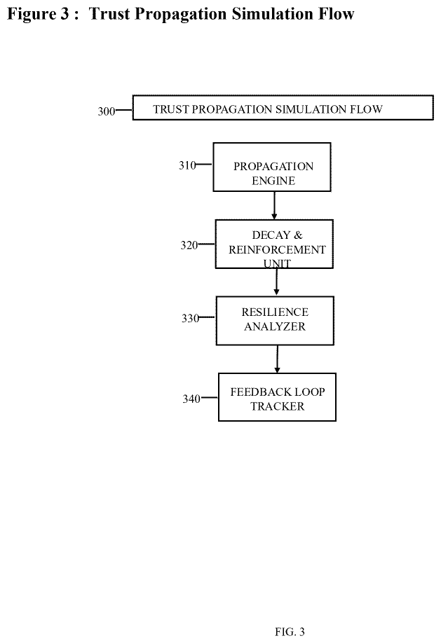

Leveraging the mapping model outputs, this module simulates trust diffusion through propagation engines, reinforcement and decay routines, resilience analysis, and iterative feedback loop tracking. The result is a time-based projection of how trust relationships evolve across the network. (Expanded in FIG. 3).

### Adaptive Group Design Panel (400):

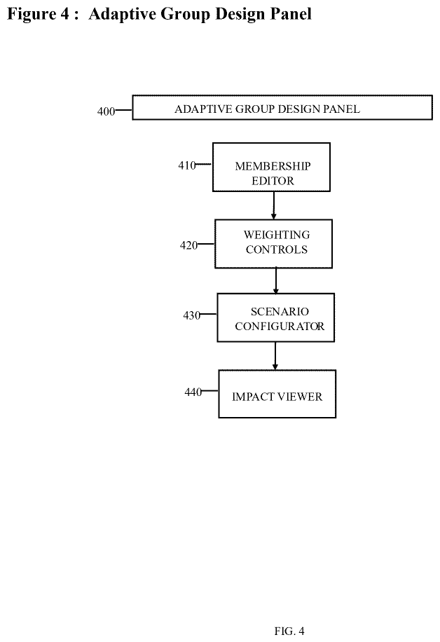

This interactive module allows stakeholders to reconfigure group structures, testing alternative membership compositions, weighting assignments, and scenario parameters. Outputs are rendered through an impact visualization layer, providing measurable outcomes for each tested configuration. (Expanded in FIG. 4).

### Group Performance Forecast Dashboard (500):

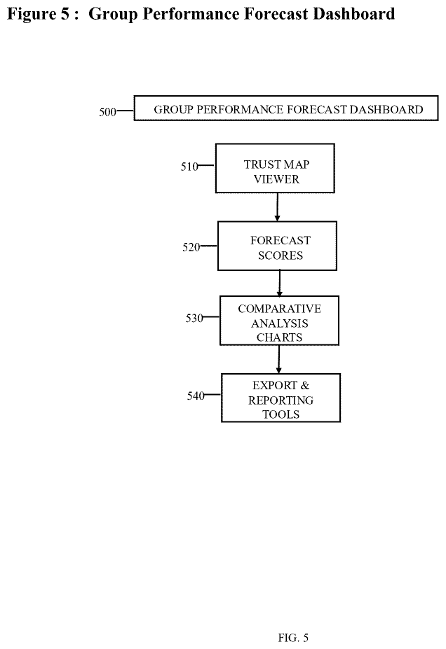

The final module aggregates outputs into an actionable visualization and reporting framework. It includes trust map viewers, forecast scoring, comparative analysis charts, and export tools designed to produce compliance-ready, auditable reports. (Expanded in FIG. 5).

### System Flow:

Taken together, FIG. 1 demonstrates the GNT Engine (100) as an end-to-end architecture. Integrity is established at the input and validation stages (110-120), relational and membership structures are distinguished (130-140), data is harmonized through a dedicated integration layer (150), and results are transformed into indices (200), simulations (300), adaptive optimizations (400), and forecasts (500). The system is modular, extensible, and deployable across on-premises and cloud-based infrastructures, enabling robust scaling and interoperability across industries.

### Detailed Description of FIG. 2—Group Influence Mapping Model (200-240)

FIG. 2 illustrates the Group Influence Mapping Model (200), which transforms validated relationship and membership records into structured indices that quantify cohesion, positional centrality, and balance of trust within a network. The model further generates trust maps that provide quantitative and visual decision-support artifacts for organizational analysis, governance, and design. The module is configured to function independently or as an integrated component of the GNT Engine.

### Cohesion Index (210):

The Cohesion Index measures intra-group unity by calculating the density of verified connections relative to the total possible ties among members. A higher cohesion score indicates strong collective integration, while lower values indicate fragmentation or structural silos. This metric provides an auditable measure of group connectedness.

### Centrality Index (220):

The Centrality Index evaluates the positional importance of individual members by analyzing direct and indirect relational pathways. This measure identifies actors with disproportionate influence over trust propagation, decision-making, and group stability. High centrality scores highlight potential leaders or hubs, while also identifying potential bottlenecks or points of systemic vulnerability.

### Balance Index (230):

The Balance Index assesses the distribution of trust and influence across the network. It distinguishes between equitable trust reciprocity and disproportionate concentration of influence in a limited subset of actors. Balanced configurations enhance resilience and fairness, while imbalances may indicate structural dependencies or risks of dominance.

### Trust Map Generator (240):

The Trust Map Generator integrates outputs from the Cohesion, Centrality, and Balance Indices to produce data-driven and graphical representations of group trust pathways. These trust maps depict dependencies, influence flows, and reciprocity patterns, enabling comparative analysis, scenario testing, and export to downstream modules such as trust propagation simulation or adaptive group design.

Collectively, the Group Influence Mapping Model (200) establishes a standardized and auditable foundation for subsequent operations of the GNT Engine. The indices (210-240) provide validated and repeatable metrics that support trust propagation simulations (300), adaptive group design (400), and performance forecasting (500).

### Detailed Description of FIG. 3—Trust Propagation Simulation Flow (300-340)

FIG. 3 illustrates the Trust Propagation Simulation Flow (300), which models the dynamic movement of trust and influence across a network under variable conditions. The module enables predictive analysis by simulating diffusion, reinforcement, decay, and recovery of trust signals between members. It supports stress testing, scenario evaluation, and governance optimization by revealing how trust pathways evolve over time.

### Propagation Engine (310):

The Propagation Engine initiates and simulates the flow of trust signals throughout the network. It incorporates relational strength, positional influence of central actors, and structural pathways as identified by the Group Influence Mapping Model (200). This submodule predicts which nodes or subgroups are most effective in transmitting trust, and which may act as barriers or points of signal attenuation.

### Decay and Reinforcement Unit (320):

The Decay and Reinforcement Unit introduces temporal and contextual dynamics into the simulation. Trust signals weaken when relationships degrade, interactions remain unreciprocated, or negative events occur. Conversely, trust strengthens when members collaborate, align goals, or demonstrate repeated positive exchanges. By modeling both erosion and reinforcement, the unit captures nonlinear trust trajectories and produces forecasts that reflect real-world complexity.

### Resilience Analyzer (330):

The Resilience Analyzer evaluates the network's ability to sustain trust pathways under stress conditions. It measures continuity when influential nodes are removed, when conflicting interests emerge, or when disruptive events occur. By quantifying resilience thresholds, the analyzer identifies vulnerabilities and highlights design strategies that preserve integrity and cohesion of trust networks under adverse scenarios.

### Feedback Loop Tracker (340):

The Feedback Loop Tracker monitors iterative and reciprocal exchanges of trust. It detects whether signals circulate in reinforcing cycles—producing compounding positive effects—or dissipate after initial propagation. This functionality distinguishes between virtuous cycles of strengthening trust and downward spirals of erosion, enabling timely interventions and adaptive reconfiguration.

Collectively, the Trust Propagation Simulation Flow (300) provides an adaptive, auditable, and scenario-driven framework for evaluating group stability. It bridges static influence measurements with dynamic trust simulations, enabling governance entities to anticipate outcomes, design resilient structures, and optimize decision-making.

### Detailed Description of FIG. 4—Adaptive Group Design Panel (400-440)

FIG. 4 illustrates the Adaptive Group Design Panel (400), which provides an interactive environment for evaluating, reconfiguring, and optimizing group structures. The module converts validated influence, trust, and membership data into actionable design options that may be aligned with organizational missions and tested against predicted outcomes. Operating as a decision-support layer, it enables stakeholders to experiment with structural adjustments and immediately assess projected impacts.

### Membership Editor (410):

The Membership Editor facilitates the addition, removal, or reassignment of individuals within a group. It incorporates validated membership and relational records to ensure that modifications remain auditable and traceable. The editor supports dynamic adjustments such as role reassignment, subgroup formation, and participation-level redefinition, enabling users to evaluate the organizational impact of alternative membership configurations.

### Weighting Controls (420):

The Weighting Controls allow users to assign relative weights to factors such as trust, cohesion, centrality, and mission alignment. By adjusting these values, stakeholders can prioritize outcomes according to organizational objectives. For example, simulations may emphasize resilience and trust distribution over centrality, or vice versa, depending on governance requirements. This functionality ensures that predicted outcomes reflect context-specific priorities.

### Scenario Configurator (430):

The Scenario Configurator enables the construction of hypothetical test conditions, including leadership transitions, the introduction of new members, or the simulation of crisis events. It provides a controlled environment for evaluating how group structures respond to disruptive variables. By running scenario-based simulations, organizations gain foresight into vulnerabilities, adaptive capacities, and potential strategies for strengthening group resilience.

### Impact Viewer (440):

The Impact Viewer presents the projected results of membership edits, weighting adjustments, and scenario simulations. It generates quantitative impact scores and graphical outputs such as alignment charts and comparative outcome visualizations. By integrating metrics with visual representations, the viewer enables stakeholders to evaluate trade-offs transparently, supporting data-driven and evidence-based decision-making.

Collectively, the Adaptive Group Design Panel (400) provides a dynamic, auditable, and interactive framework for organizational design. Its submodules (410-440) empower decision-makers to refine group structures iteratively, evaluate resilience under stress, and align coalitions with long-term mission objectives.

### Detailed Description of FIG. 5—Group Performance Forecast Dashboard (500-540)

FIG. 5 illustrates the Group Performance Forecast Dashboard (500), which serves as a centralized interface for presenting predictive analytics, simulation outputs, and comparative evaluations. The dashboard aggregates results from the Group Influence Mapping Model, Trust Propagation Simulation Flow, and Adaptive Group Design Panel to provide actionable insights for governance, compliance, and long-term strategic planning. Designed for transparency and scalability, the dashboard supports real-time visualization, comparative evaluation, and exportable reporting.

### Trust Map Viewer (510):

The Trust Map Viewer generates interactive visualizations of relational trust across a group or coalition. It highlights resilient pathways, strong and weak ties, and potential structural vulnerabilities. By dynamically rendering trust networks, the viewer enables stakeholders to interpret evolving trust dynamics, identify points of fragility, and prioritize areas for intervention or reinforcement.

### Forecast Scores (520):

The Forecast Scores module produces quantitative indices representing predicted group performance under varied conditions. These indices integrate cohesion, centrality, propagation resilience, and mission alignment metrics into a composite predictive score. Outputs may be expressed as numerical values, percentile benchmarks, or scenario-specific ratings, offering standardized, auditable measures of group stability and effectiveness.

### Comparative Analysis Charts (530):

The Comparative Analysis Charts provide side-by-side evaluations of multiple group structures, scenarios, or timeframes. By visualizing tradeoffs between competing priorities—such as efficiency versus resilience or centrality versus distributed trust—the charts support transparent, data-driven decision-making. This feature enables stakeholders to evaluate alternative pathways and select optimal designs aligned with organizational objectives.

### Export and Reporting Tools (540):

The Export and Reporting Tools generate compliance-ready documentation in multiple standardized formats, including charts, tables, and executive summaries. Outputs include metadata such as scenario definitions, weighting parameters, and validation methods, ensuring reproducibility and auditability. These reports may be integrated into governance filings, performance evaluations, or regulatory submissions.

Collectively, the Group Performance Forecast Dashboard (500) provides decision-makers with validated, scenario-tested insights in both graphical and quantitative form. Its submodules (510-540) bridge advanced modeling with operational governance, delivering a scalable and auditable framework for organizational performance forecasting.

### Worked Computational Example

### Scenario

A group network consists of five nodes (A-E). Directed, weighted edges represent trust relationships, where the weight corresponds to the strength of trust from one member to another. The defined edges are:

$$\begin{matrix}\text{?} & A \to B ( 0.6 ) \\ \text{?} & A \to C ( 0.4 ) \\ \vert & B \to D ( 0.7 ) \\ \text{?} & C \to D ( 0.5 ) \\ \text{?} & C \to E ( 0.3 ) \\ \text{?} & D \to E ( 0.8 )\end{matrix}$$

### Algorithm

1. Initialization: Node A is the trust origin. Trust [A]=1.0; all others=0.0.
2. Propagation: At each iteration, trust is propagated along outgoing edges, applying edge weights and a decay factor (0.95 per iteration).
3. Iteration: Trust values are updated across three iterations.
4. Normalization: Values are scaled relative to the maximum observed trust score.

### Results (Pre-Normalization)

### Node Iteration 1 Iteration 2 Iteration 3 Final Value

| | | | | |
|---|---|---|---|---|
| A | 1.00 | 1.00 | 1.00 | 1.00 |
| B | 0.60 | 0.60 | 0.60 | 0.60 |
| C | 0.40 | 0.40 | 0.40 | 0.40 |
| D | 0.00 | 0.62 | 0.62 | 0.62 |
| E | 0.00 | 0.00 | 0.62 | 0.62 |

### Normalized Final Values (Relative to Max=1.0):

$$\text{?} A = 1.$$

$$\text{?} B \approx 0.6$$

$$\text{?} C \approx 0.4$$

$$\text{?} \text{?} \text{?} D \approx 0.62$$

$$\text{?} E \approx 0.62$$

### Resilience Test

If node C is removed (simulating turnover or failure):

$$\text{?} D receives only 0.42 from B ( vs . 0.62 baseline ) .$$

$$\text{?} E receives 0.42 \times 0.8 = 0.34 ( vs . 0.62 baseline ) .$$

$$\text{?} Overall resilience drops by ∼ 45 \% , demonstrating the Resilience Analyzer ( 330 ) function .$$

### Interpretation

This example illustrates how the Propagation Engine (310) distributes trust across the network, how the Decay and Reinforcement Unit (320) attenuates values, and how the Feedback Loop Tracker (340) manages multi-iteration propagation. The resulting outputs provide transparent, reproducible trust distributions and resilience analyses that can be directly applied to governance and coalition optimization scenarios.

1. A computer-implemented system (100) for modeling, analyzing, and optimizing group dynamics, comprising:
a data ingestion and validation module configured to receive authenticated membership and relationship records from independent repositories and to perform consensus corroboration, anomaly screening, provenance hashing, and privacy safeguards to produce validated multi-source data;
a group influence mapping model (200) configured to construct a graph representation of a group from the validated multi-source data, compute indices including cohesion, centrality, and balance, and generate a trust map;
a trust propagation simulation flow (300) configured to apply reinforcement and decay dynamics to the graph representation, evaluate resilience under perturbations, and produce time-series trajectories;
an adaptive group design panel (400) configured to accept configuration inputs specifying membership, weightings, and structural constraints, to perform scenario testing on candidate configurations, and to output quantified impact measures; and
a performance forecast dashboard (500) configured to present the trust map, composite forecast scores, comparative benchmarks, and exportable machine-auditable reports.

2. The system of claim 1, wherein the data ingestion and validation module performs identity resolution across the independent repositories using deterministic keys, probabilistic matching, or cryptographic fingerprints.

3. The system of claim 1, wherein the provenance hashing records normalized inputs, configuration states, and selected outputs to form an auditable chain of custody.

4. The system of claim 3, wherein the provenance hashes are anchored to a blockchain.

5. The system of claim 1, wherein the trust propagation simulation flow (300) computes a resilience score that reflects stability of performance or connectivity under specified perturbations.

6. The system of claim 1, wherein the adaptive group design panel (400) invokes an optimization routine that selects a candidate configuration maximizing an objective subject to constraints.

7. The system of claim 1, wherein the performance forecast dashboard (500) provides programmatic access to the composite forecast scores and trust map via an application programming interface.

8. The system of claim 1, wherein the privacy safeguards comprise access controls and pseudonymization of sensitive attributes.

9. The system of claim 1, wherein the comparative benchmarks reported by the performance forecast dashboard (500) are derived from peer groups or historical cohorts.

10. The system of claim 1, wherein the group influence mapping model (200) generates a directed trust map with edge weights derived from the validated multi-source data.

11. The system of claim 1, wherein training or scoring of one or more models is performed via federated learning across distributed repositories without sharing raw data.

12. The system of claim 1, wherein at least a portion of identity resolution or provenance hashing executes within a hardware-backed trusted execution environment (secure enclave).

13. The system of claim 1, wherein reinforcement and decay parameters of the trust propagation simulation flow (300) are configurable per relationship category.

14. The system of claim 1, wherein the performance forecast dashboard (500) comprises an Export and Reporting Tools subcomponent (540) configured to output machine-readable artifacts comprising metric values, model configurations, and associated provenance identifiers.

15. A computer-implemented method for modeling, analyzing, and optimizing group dynamics, comprising:
receiving authenticated membership and relationship records from independent repositories;
validating the records by performing consensus corroboration, anomaly screening, provenance hashing, and privacy safeguards to produce validated multi-source data;
constructing a graph representation of a group from the validated multi-source data;
computing indices including cohesion, centrality, and balance and generating a trust map;
simulating propagation of influence and trust over the graph using reinforcement and decay dynamics, including evaluating resilience under perturbations to produce time-series trajectories;
receiving configuration inputs specifying membership, weightings, or structural constraints;
performing scenario testing to quantify impacts of candidate configurations; and
producing outputs comprising composite forecast scores, comparative benchmarks, and exportable machine-auditable reports.

16. The method of claim 15, further comprising computing a resilience score from the simulation results.

17. The method of claim 15, wherein validating the records comprises identity resolution across repositories using deterministic keys, probabilistic matching, or cryptographic fingerprints.

18. The method of claim 15, further comprising anchoring provenance hashes to a blockchain.

19. The method of claim 15, wherein at least one of training or scoring is performed via federated learning across distributed repositories without sharing raw data.

20. A non-transitory computer-readable medium storing instructions that, when executed by one or more processors, cause a computing system to perform the method of any of claims 15-19.
